(19) United States
(12) Patent Application Publication
(10) Pub. No.: US 2022/0385491 A1
(43) Pub. Date: Dec. 1, 2022

(54) Real-Time Speaker Selection for Multiparty Conferences

(71) Applicant: Avaya Management L.P., Durham, NC (US)

(72) Inventors: Tommy Morris, Mervue (IR); Dara Geary, Mervue (IE)

(21) Appl. No.: 17/332,112

(22) Filed: May 27, 2021

(51) Int. Cl. H04L 12/18

(52) U.S. Cl. CPC H04L 12/1822; H04L 12/1818

(57) ABSTRACT

A method includes receiving a selection of at least one priority algorithm to be applied during a conference call to determine which participant has priority when an attempt is made by more than one participant to speak at substantially a same time. The method further includes detecting the attempt made by the more than one participant to speak at substantially the same time, applying the received selection of the at least one priority algorithm to determine which participant of the more than one participant has priority and selecting one participant of the more than one participant that attempted to speak at substantially the same time as the speaker.

### FIELD OF THE DISCLOSURE

Embodiments of the present disclosure relate generally to systems and methods for multi-participant communication conferencing and more particularly to systems and methods for managing participants to a conference call based on fairness.

### BACKGROUND

In multi-participant communication conferencing, there are occasions where more than one participant wants to speak at the same time. One conventional approach to resolve this issue provides a communication server, such as a media server for example, used to monitor the different audio signals output by each participant to detect when there are concurrent participants trying to speak at the same time. Real-time voice analysis (or media analysis) by the media server is used to generate a queuing system based on the detected speech from the participants. The queueing system allows a first participant with earlier detected speech to finish speaking before a second participant with later detected speech to begin speaking. Allowances can also be made based on the participant's connectivity to the conference call. An alternative approach provides a predefined priority scheme, generated before the start of the conference call, which prioritizes the participants based on rank or position within an organization. Hence, there is a need for improved methods and systems for managing participants to a conference call based on fairness.

### SUMMARY

These and other needs are addressed by the various embodiments and configurations of the present disclosure. The present disclosure can provide a number of advantages depending on the particular configuration. These and other advantages will be apparent from the disclosure contained herein.

In one embodiment of the present disclosure, a method for managing a conference call is disclosed. The method includes receiving, by a processor, a request to initiate a conference call with a plurality of participants and initiating, by the processor, the conference call with the plurality of participants in response to receiving an acceptance from at least two of the plurality of participants. The method also includes receiving, by the processor, a selection of at least one priority algorithm to be applied during the conference call to determine which participant has priority as a speaker when an attempt is made by more than one participant to speak at substantially a same time and detecting, by the processor, the attempt made by the more than one participant to speak at substantially the same time. The method further includes applying, by the processor, the received selection of at least one priority algorithm to determine which participant of the more than one participant that attempted to speak at substantially the same time has priority and selecting, by the processor, one participant of the more than one participant that attempted to speak at substantially the same time as the speaker.

In another embodiment of the present disclosure, a system is disclosed. The system includes a processor and a memory coupled with and readable by the processor and having stored therein a set of instructions which, when executed by the processor, causes the processor to manage a conference call by receiving a request to initiate a conference call with a plurality of participants and initiating the conference call with the plurality of participants in response to receiving an acceptance from at least two of the plurality of participants. Also, when executed by the processor, causes the processor to manage a conference call by receiving a selection of at least one priority algorithm to be applied during the conference call to determine which participant has priority as a speaker when an attempt is made by more than one participant to speak at substantially a same time and detecting the attempt made by the more than one participant to speak at substantially the same time. Further when executed by the processor, causes the processor to manage a conference call by applying the received selection of at least one priority algorithm to determine which participant of the more than one participant that attempted to speak at substantially the same time has priority and selecting one participant of the more than one participant that attempted to speak at substantially the same time as the speaker.

In a further embodiment of the present disclosure, a non-transitory computer-readable medium is disclosed. The non-transitory computer-readable medium comprises a set of instructions stored therein which, when executed by a processor, causes the processor to manage a conference call by receiving a request to initiate a conference call with a plurality of participants and initiating the conference call with the plurality of participants in response to receiving an acceptance from at least two of the plurality of participants. The processor also manages the conference call by receiving a selection of at least one priority algorithm to be applied during the conference call to determine which participant has priority as a speaker when an attempt is made by more than one participant to speak at substantially a same time and detecting the attempt made by the more than one participant to speak at substantially the same time. The processor further manages the conference call by applying the received selection of at least one priority algorithm to determine which participant of the more than one participant that attempted to speak at substantially the same time has priority and selecting one participant of the more than one participant that attempted to speak at substantially the same time as the speaker.

The preceding is a simplified summary of the disclosure to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures.

FIG. 1 is a block diagram of an illustrative computing environment for managing participants to a conference call based on fairness according to embodiments of the present disclosure.

FIG. 2 is a block diagram of an illustrative communication device used for managing participants to a conference call based on fairness according to an embodiment of the present disclosure.

FIG. 3 is a block diagram of an illustrative conference server used for managing participants to a conference call based on fairness according to an embodiment of the present disclosure.

FIG. 4 is a block diagram of an illustrative communication system for managing participants to a conference call based on fairness according to an embodiment of the present disclosure.

FIG. 5 is a flow diagram of a method used for managing participants to a conference call based on fairness according to an embodiment of the present disclosure.

FIG. 6 is a flow diagram illustrating additional details of the method used for managing participants to a conference call based on fairness according to an embodiment of the present disclosure.

FIGS. 7A-7E are block diagrams of illustrative database entries used for managing participants to a conference call based on fairness according to embodiments of the present disclosure.

FIG. 8 is a screenshot illustrating an exemplary user interface used in managing participants to a conference call based on fairness according to an embodiment of the present disclosure.

FIG. 9A is a screenshot illustrating an exemplary user interface used in managing participants to a conference call based on fairness according to an embodiment of the present disclosure.

FIG. 9B is a block diagram of an illustrative database entry used for managing participants to a conference call based on fairness according to an embodiment of the present disclosure.

FIG. 10 is a screenshot illustrating an exemplary user interface used in managing participants to a conference call based on fairness according to an embodiment of the present disclosure.

FIG. 11 is a screenshot illustrating an exemplary user interface used in managing participants to a conference call based on fairness according to an embodiment of the present disclosure.

FIG. 12 is a screenshot illustrating an exemplary user interface used in managing participants to a conference call based on fairness according to an embodiment of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the exemplary embodiments will provide those skilled in the art with an enabling description for implementing an exemplary embodiment. It should however be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a local area network (LAN) and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, 13, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “conference” as used herein refers to any communication or set of communications, whether including audio, video, text, or other multimedia data, between two or more communication endpoints and/or users. Typically, a conference includes three or more communication endpoints. The terms “conference” and “conference call” are used interchangeably throughout the specification.

The term “communication device” or “communication endpoint” as used herein refers to any hardware device and/or software operable to engage in a communication session. For example, a communication device can be an Internet Protocol (IP)-enabled phone, a desktop phone, a cellular phone, a personal digital assistant, a soft-client telephone program executing on a computer system, etc. IP-capable hard- or softphone can be modified to perform the operations according to embodiments of the present disclosure. Examples of suitable modified IP telephones include the 5600®, 9620™, 9630™, 9640™, 9640G™, 9650™, and Quick Edition telephones and IP wireless telephones of Avaya, Inc.

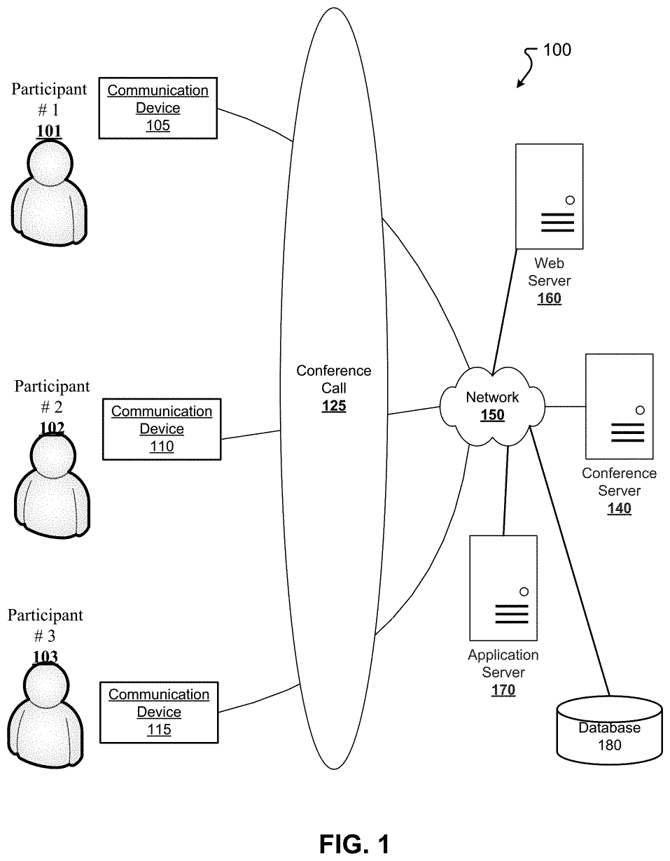

The term “network” as used herein refers to a system used by one or more users to communicate. The network can consist of one or more session managers, feature servers, communication endpoints, etc. that allow communications, whether voice or data, between two users. A network can be any network or communication system as described in conjunction with FIG. 1. Generally, a network can be a LAN, a wide area network (WAN), a wireless LAN, a wireless WAN, the Internet, etc. that receives and transmits messages or data between devices. A network may communicate in any format or protocol known in the art, such as, transmission control protocol/internet protocol (TCP/IP), 802.11g, 802.11n, Bluetooth, or other formats or protocols.

The term “database” or “data model” as used herein refers to any system, hardware, software, memory, storage device, firmware, component, etc., that stores data. The data model can be any type of database or storage framework which is stored on any type of non-transitory, tangible computer readable medium. The data model can include one or more data structures, which may comprise one or more sections that store an item of data. A section may include, depending on the type of data structure, an attribute of an object, a data field, or other types of sections included in one or more types of data structures. The data model can represent any type of database, for example, relational databases, flat file databases, object-oriented databases, or other types of databases. Further, the data structures can be stored in memory or memory structures that may be used in either run-time applications or in initializing a communication.

The term “computer-readable medium” as used herein refers to any tangible storage and/or transmission medium that participate in providing instructions to a processor for execution. The computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, etc. Such a medium may take many forms, including but not limited to, non-volatile media, volatile media, and transmission media. Non-volatile media includes, for example, non-volatile random access memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment of the present disclosure, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a sub element identifier when a sub element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

In some embodiments of the present disclosure, a communication system, such as a conferencing communication system for example, continues to be employed for multiple participants to a conference call (e.g., conferences), augmented with a function that allows for each participant of the conference call to speak based on fairness and network capabilities, that is for example, overlaid on the conferencing communication system. Conference calls (also known as teleconferences) are routinely used to communicate interactively among a plurality of persons, referred to as participants. The conference calls may be used by participants in different locations, and in some cases, in remote locations that are dispersed geographically. Commonly, the conference calls are performed over the Internet, for example, by exploiting Voice over Internet Protocol (IP) (VoIP) techniques. The conference calls provide a live exchange of sounds among the participants (i.e., their voices). Moreover, the conference call may also support the sharing of multi-media contents, such as video, images, data, documents and so on.

According to one embodiment of the present disclosure, a priority algorithm eliminates dead silence created by interrupts when two or more participants begin to speak at the same time during the conference call, and then pause and wait for the other party to begin speaking, not realizing that the other participant is also waiting for the other participant to start speaking. This dead silence contributes to a significant amount of wasted time during the conference call. For example, when several participants to a conference call jump in and start speaking at the same time during a silent period during the conference call, the system may use one or more priority algorithms to avoid interrupts during the conference call. According to further embodiments of the present disclosure, systems and methods provide for detecting voice signals of multiple speakers (e.g., participants to a conference call) that interfere with each other. The priority algorithms determine which speaker should go first. The system then mutes the other participants to the conference call. The priority algorithm avoids having participant(s) to the conference call that constantly creates interruptions during the conference call, speaking over the other participants and not allowing the other participants to speak. According to embodiments of the present disclosure, visual and/or audio notifications may be provided to the participants to the conference call to indicate when a participant has been muted. In addition, visual and/or audio queues are provided to the participants to the conference call such that the participants know where he or she is in the queue to ask questions or speak.

FIG. 1 is a block diagram of an illustrative computing environment 100 for managing participants to a conference call according to embodiments of the present disclosure. The illustrative system 100 includes a plurality of users, here a first user 101, a second user 102 and a third user 103, a plurality of communication devices 105, 110, 115, a conference call 125, a network 150, a conference server 140, a web server 160, an application server 170 and database 180. According to one embodiment of the present disclosure, the conference call 125 can be a videoconference or conference call and the conference call 125 is supported by the conference server 140.

Communication devices 105, 110, 115 can be or may include any user communication endpoint device that can communicate over the network 150 providing one-way or two-way audio and/or video communication with other communication devices and the conference server 140. The communication devices 105, 110, 115 may include general purpose personal computers (including, merely by way of example, personal computer (PC)s, and/or laptop computers running various versions of Microsoft Corp.'s Windows® and/or Apple Corp.'s Macintosh-@ operating systems) and/or workstation computers running any of a variety of commercially-available UNIX® or UNIX-like operating systems. These communication devices 105, 110, 115 may also have any of a variety of applications, including for example, database client and/or server applications, and web browser applications. Alternatively, the communication devices 105, 110, 115 may be any other electronic device, such as a thin-client computer, Internet-enabled mobile telephone, video system, a cellular telephone, a tablet device, a notebook device, an iPad, a smartphone, a personal digital assistant (PDA), and/or the like capable of communicating via network 150 and/or displaying and navigating web pages or other types of electronic documents or information Although the exemplary system 100 is shown with three communication devices, any number of user communication devices may be supported.

The communication devices 105, 110, 115 are devices where a communication session ends. The communication devices 105, 110, 115 are not network elements that facilitate and/or relay information in the network, such as a communication manager or router. In one embodiment of the present disclosure, the communication devices 105, 110, 115 are portable (e.g., mobile) devices. In another embodiment, the communication devices 105, 110, 115 are stationary devices. In a further embodiment of the present disclosure, the communication devices 105, 110, 115 are a combination of portable device and stationary devices. The communication devices 105, 110, 115 may provide any combination of several different types of inputs and/or output, such as speech only, speech and data, a combination of speech and video, or a combination of speech, data and video. Information communicated between the communication devices 105, 110, 115 and/or the conference server 140 may include control signals, indicators, audio information, video information, and data.

Network 150 can be or may include any collection of communication equipment that can send and receive electronic communications, such as the Internet, a Wide Area Network (WAN), a Local Area Network (LAN), a VoIP network, the Public Switched Telephone Network (PSTN), a packet switched network, a circuit switched network, a cellular network, a combination of these, and the like. Network 150 can use a variety of electronic protocols, such as Ethernet, IP, Session Initiation Protocol (SIP), Integrated Services Digital Network (ISDN), email protocols, text messaging protocols (e.g., Short Message Service (SMS)), and/or the like. Thus, network 150 is an electronic communication network configured to carry messages via packets and/or circuit switched communications.

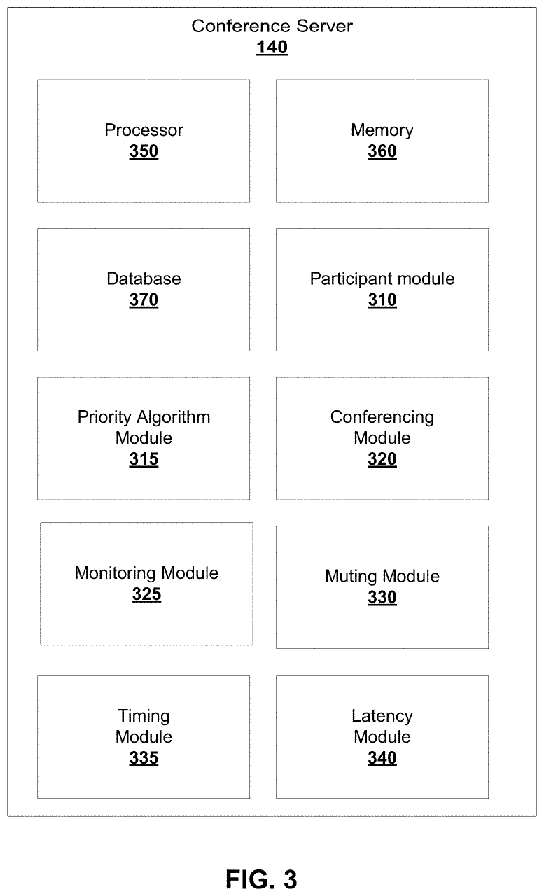

As mentioned above, system 100 includes one or more servers 140, 160, 170. According to one embodiment of the present disclosure, server 140 is shown as a conference server, server 160 is shown as a web server and server 170 is shown as an application server. The conference server 140 is discussed in greater detail in FIG. 3. The web server 160 may be used to process requests for web pages or other electronic documents from communication devices 105, 110, 115. The web server 160 can be running an operating system including any of those discussed above, as well as any commercially-available server operating systems. The web server 160 can also run a variety of server applications, including SIP (Session Initiation Protocol) servers, HTTP(s) servers, FTP servers, CGI servers, database servers, Java® servers, and the like.

The file and or/application server 170, in addition to including an operating system, includes one or more applications accessible by a client running on one or more of the communication devices 105, 110, 115. The server(s) 160 and/or 170 may be one or more general purpose computers capable of executing programs or scripts in response to the communication devices 105, 110, 115. As one example, the servers 160, 170 may execute one or more web applications. The web application may be implemented as one or more scripts or programs written in any programming language, such as Java®, C, C#®, or C++, and/or any scripting language, such as Perl, Python, or TCL, as well as combinations of any programming/scripting languages. The application server 170 may also include database servers, including without limitation those commercially available from Oracle-, Microsotl®, Sybase®, IBM® and the like, which can process requests from database clients running on a communication device 105, 110, 115.

According to embodiments of the present disclosure, the application server 170 may include Artificial Intelligence (AI) processes that identify topics and keywords in a current conference call that were recorded from previous conference calls as discussed in greater detail below.

The web pages created by the server 160 and/or 170 may be forwarded to a communication device 105, 110, 115 via a web (file) server 160, 170. Similarly, the web server 160 may be able to receive web page requests, web services invocations, and/or input data from a communication device 105, 110, 115 (e.g., a user computer, etc.) and can forward the web page requests and/or input data to the web (application) server 170. In further embodiments, the server 170 may function as a file server. Although for ease of description, FIG. 1 illustrates a separate web server 160 and file/application server 170, those skilled in the art will recognize that the functions described with respect to servers 160, 170 may be performed by a single server and/or a plurality of specialized servers, depending on implementation-specific needs and parameters. The communication devices 105, 110, 115, web (file) server 160 and/or web (application) server 170 may function as the system, devices, or components described herein.

The database 180 may reside in a variety of locations By way of example, database 180 may reside on a storage medium local to (and/or resident in) one or more of the communication devices 105, 110, 11, 140, 160, 170. Alternatively, it may be remote from any or all of the communication devices 105, 110, 115, 140, 160, 170, and in communication (e.g., via the network 150) with one or more of these. The database 180 may reside in a storage-area network (“SAN”) familiar to those skilled in the art. Similarly, any necessary files for performing the functions attributed to the communication devices 105, 110, 115, 140, 160, 170 may be stored locally on the respective computer and/or remotely, as appropriate. The database 180 may be a relational database, such as Oracle 20i®, that is adapted to store, update, and retrieve data in response to SQL-formatted commands.

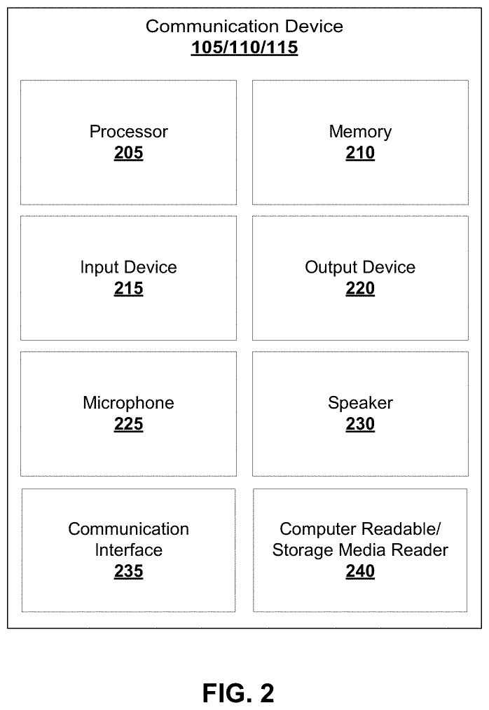

FIG. 2 is a block diagram of an illustrative communication device 105, 110, 115 used for managing participants to a conference call based on fairness according to an embodiment of the present disclosure. The communication device 105, 110, 115 may include a processor 205, a memory 210, an input device 215, an output device 220, a microphone 225, a speaker 230, a communication interface 235 and a computer-readable storage media reader 240. The communication device 105, 110, 115 may include a body or an enclosure, with the components of the communication device 105, 110, 115 being located within the enclosure. In various embodiments of the present disclosure, the communication device 105, 110, 115 includes a battery or power supply for providing electrical power to the communication device 105, 110, 115. Moreover, the components of the communication device 105, 110, 115 are communicatively coupled to each other, for example via a computer bus (not illustrated).

The processor 205, in one embodiment of the present disclosure, may include any known controller capable of executing computer-readable instructions and/or capable of performing logical operations. For example, the processor 205 may be a microcontroller, a microprocessor, a central processing unit (CPU), a graphics processing unit (GPU), an auxiliary processing unit, or similar programmable controller. In some embodiments of the present disclosure, the processor 205 executes instructions stored in the memory 210 to perform the methods and routines described herein. The processor 205 is communicatively coupled to the memory 210, the input device 215, the output device 220, the microphone 225, the speaker 230, and the communication interface 235.

The memory 210, in one embodiment of the present disclosure, is a computer readable storage medium. In some embodiments of the present disclosure, the memory 210 includes volatile computer storage media. For example, the memory 210 may include a random-access memory (RAM), including dynamic RAM (DRAM), synchronous dynamic RAM (SDRAM), and/or static RAM (SRAM). In some embodiments of the present disclosure, the memory 210 includes non-volatile computer storage media. For example, the memory 210 may include a hard disk drive, a flash memory, or any other suitable non-volatile computer storage device. In some embodiments, the memory 210 includes both volatile and non-volatile computer storage media.

In some embodiments of the present disclosure, the memory 210 stores data relating to managing a conference call. For example, the memory 210 may store physical locations associated with the conference call, devices participating in the conference call, statuses and capabilities of the participating devices, and the like. In some embodiments of the present disclosure, the memory 210 also stores program code and related data, such as an operating system operating on the communication device 105, 110, 115. In one embodiment of the present disclosure, the memory 210 stores program code for a conferencing client used to participate in the conference call.

The input device 215, in one embodiment of the present disclosure, may comprise any known computer input device including a touch panel, a button, a keypad, and the like. In certain embodiments of the present disclosure, the input device 215 includes a camera for capturing image data. In some embodiments of the present disclosure, a user may input instructions via the camera using visual gestures. In some embodiments, the input device 215 (or portions thereof) may be integrated with the output device 220, for example, as a touchscreen or similar touch-sensitive display. In some embodiments, the input device 215 comprises two or more different devices, such as a camera and a touch panel.

The output device 220, in one embodiment of the present disclosure, is configured to output visual, audible, and/or tactile signals. In some embodiments of the present disclosure, the output device 220 includes an electronic display capable of outputting visual data to a user. For example, the output device 220 may include a liquid crystal display (LCD) display, a light emitting diode (LED) display, an organic LED (OLED) display, a projector, or similar display device capable of outputting images, text, or the like to a user. In certain embodiments of the present disclosure, the output device 220 includes one or more speakers for producing sound, such as an audible alert or notification. In some embodiments of the present disclosure, the output device 220 includes one or more tactile devices for producing vibrations, motion, or other tactile outputs.

According to some embodiments of the present disclosure, all or portions of the output device 220 may be integrated with the input device 215. For example, the input device 215 and output device 220 may form a touchscreen or similar touch-sensitive display.

The microphone 225, in one embodiment of the present disclosure, comprises at least one input sensor (e.g., microphone transducer) that converts acoustic signals (sound waves) into electrical signals, thereby receiving audio signals. In various embodiments of the present disclosure, the user inputs sound or voice data (e.g., voice commands) via a microphone array. Here, the microphone 225 picks up sounds (e.g., speech) from one or more conference call participants.

The speaker 230, in one embodiment of the present disclosure, is configured to output acoustic signals. Here, the speaker 230 produces audio output, for example of a conversation or other audio content of a conference call.

The communication interface 235 may include hardware circuits and/or software (e.g., drivers, modem, protocol/network stacks) to support wired or wireless communication between the communication device 105, 110, 115 and another devices or networks, such as the network 150. Here, the communication interface 235 is used to connect the communication device 105, 110, 115 to the conference call. A wireless connection may include a mobile (cellular) telephone network. The wireless connection may also employ a Wi-Fi network based on any one of the Institute of Electrical and Electronics Engineers (IEEE) 802.11 standards. Alternatively, the wireless connection may be a BLUETOOTH® connection. In addition, the wireless connection may employ a Radio Frequency Identification (RFID) communication including RFID standards established by the International Organization for Standardization (ISO), the International Electrotechnical Commission (IEC), the American Society for Testing and Materials® (ASTM®), the DASH7™ Alliance, and EPCGlobal™. Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (IrPHY) as defined by the Infrared Data Association® (IrDA®). Alternatively, the wireless connection may be a cellular telephone network communication. All standards and/or connection types include the latest version and revision of the standard and/or connection type as of the filing date of this application.

The computer-readable storage media reader 240 can further be connected to a computer-readable storage medium, together (and, optionally, in combination with memory 210 comprehensively representing remote, local, fixed, and/or removable storage devices plus storage media for temporarily and/or more permanently containing computer-readable information. The communications interface 235 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

FIG. 3 is a block diagram of an illustrative conference server 140 used for managing participants to a conference call based on fairness according to an embodiment of the present disclosure. The conference server 140 can include a PBX, an enterprise switch, an enterprise server, or other type of telecommunications system switch or server, as well as other types of processor-based communication control devices such as media servers (i.e., email servers, voicemail servers, web servers, and the like), computers, adjuncts, etc. The conference server 140 is preferably configured to execute telecommunication applications such as Avaya Inc.'s Aura™ Media Server, Experience Portal, and Media Platform as a Service (MPaaS). These products typically require the participants to dial into a conference bridge using a predetermined dial-in number and access code to initiate conferences, without an operator or advanced reservations. As will be appreciated, these products further provide integrated features such as audio and web conference management, desktop sharing, polling, interactive whiteboard session, chat, application sharing, conference recording and playback of audio and web portions of the conference, and annotation tools.

The conference server 140 can be or may include any hardware coupled with software that can manage how a conference call is conducted and may include a conference bridge for example. As depicted, the conference server 140 includes a processor 350, a memory 360, a database 370 and one or more of a plurality of modules including a participant module 310, a priority algorithm module 315, a conferencing module 320, a monitoring module 325, a muting module 330, a timing module 335 and a latency module 340. The modules 310-340 may be implemented as hardware, software, or a combination of hardware and software (e.g., processor 350, memory 360 and database 370).

Processor 350 and memory 360 are similar to processor 205 and memory 210, respectively, as discussed in FIG. 2 and database 370 is similar to database 180 illustrated in FIG. 1. Therefore, further discussions regarding these features have been omitted.

The participant module 310 according to one embodiment of the present disclosure, is configured to include identifying information about a participant to the conference call. According to one embodiment of the present disclosure, each participant to the conference call is registered as a user to at least one conference provided by the conference server 140. According to one embodiment of the present disclosure, a registered user previously provides identifying information about the user (e.g., a name, a user identity, a unique identifier (II)), an email address, a telephone number, an IP address, etc.), in memory 360 or database 370. Generally, when a user is invited to a conference call or creates a conference call to become a participant, the user receives a set of information, such as a telephone number and access code or a web conference link, to join the conference. According to one embodiment of the present disclosure, when the time of the conference arrives, the user and the other invited participants must first access the conference dial-in or other information to join the conference.

The monitoring module 325 detects the speech of each of the participants to the conference call and in cooperation with the priority algorithm 315, determines which participant speaks first when more than one participant to the conference call is trying to speak at the same time. The monitoring module 325 determines the context of the conference call by analyzing speech of the participants, according to an embodiment of the present disclosure. In an embodiment of the present disclosure, a speech analyzer (not shown) may be used for speech related communication sessions, e.g., a voice session, to determine the context of the conference call. The speech analyzer can use techniques known in the art, and various forms of processing may be used to analyze audio signals from the participants to the conference call to detect speech.

A text analyzer (not shown) may be used for text related communication sessions, e.g., a web chat, a text message, and so forth, to determine the context of the conference call. A video analyzer (not shown) may be used for video related communication sessions, e.g, a video session, to determine the context of the conference call. According to embodiments of the present disclosure, the monitoring module 325 may monitor past communication histories of conference calls between some or all of the participants of a present conference call. Furthermore, monitoring module 325 may extract keywords from previous conference calls to be used in subsequent conference calls, according to an embodiment of the present disclosure. In an exemplary scenario, if a meeting topic for a previous conference entitled “Database Management”, then “database”, “management”, “columns”, “projection,” etc. and other terms associated with “database”, “management”, “database management” and various combinations thereof, may be extracted as keywords from the previous conference call(s) and used in a subsequent conference call. The database 370 may store the monitored communication sessions, according to an embodiment of the present disclosure. The selection of the topics, keywords and other terms may be based on one or more rules that can be predefined, administered, learned using AI and/or the like.

According to embodiments of the present disclosure, if a participant to the conference call wants to participate (e.g., ask a question or provide a comment) but is unable, the participant can write into a chat window of the conference call indicating that the participant wants to say something during the conference call. The monitoring module 325 in association with the AI from the application server 170, monitors chat messages to determine which participant(s) want to say something during the conference call. For example, if a participant is having audio difficulties, cannot seem to break into the conference call or wants to reserve a later time to speak during the conference call when a specific topic is going to be discussed, the monitoring module 325 and the AI from the application server 170 monitors this information. Moreover, if a participant communicates with the conference host or to other participants via, emails, IM, chat messages, etc., that the participant cannot get an opportunity to speak, then the AI from the application server 170 recognizes the participant's attempt to speak during the conference call and places the participant in a queue to speak. Various AI applications can be trained to extract insight from a given data set including for example, Cognigy.AI or Voice Gateway of Cognigy, LLC. According to an embodiment of the present disclosure, conferencing module 320 polls the participants and asks the participants “Did you want to enter the conversation?” to make sure the participants have been able to say what was on their mind.

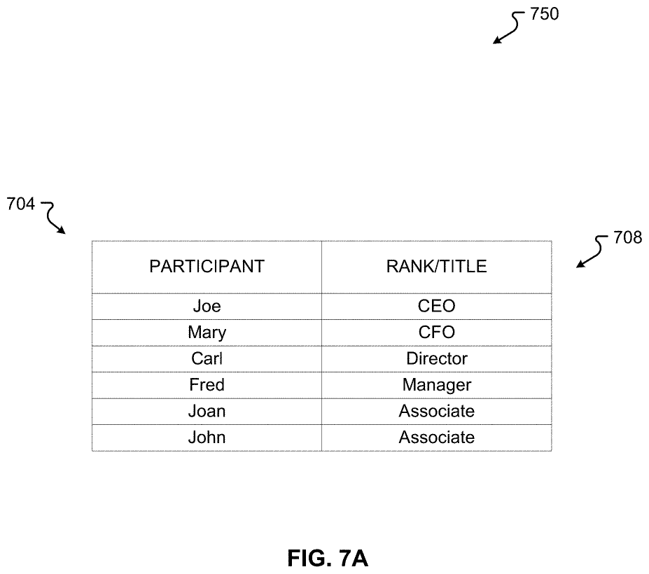

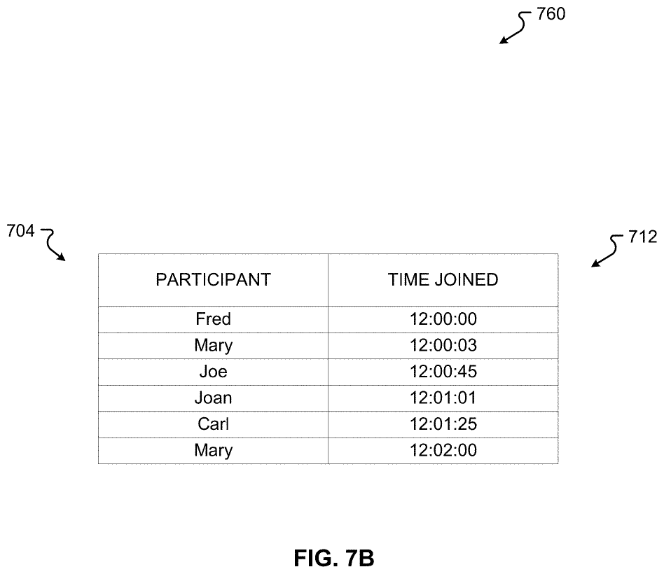

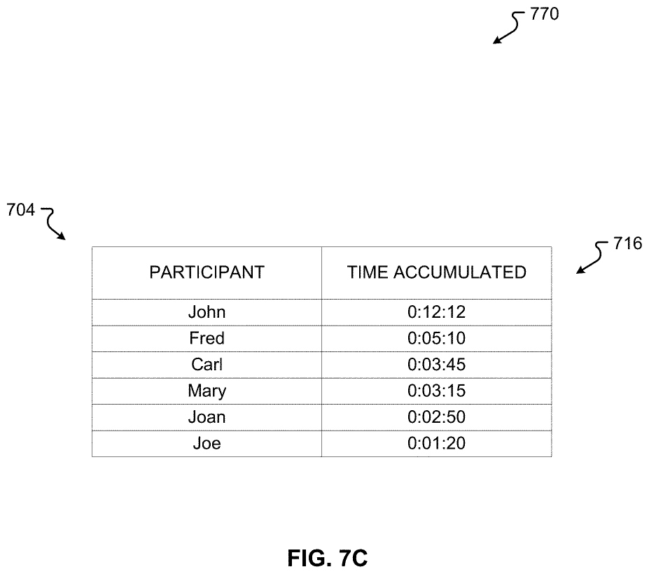

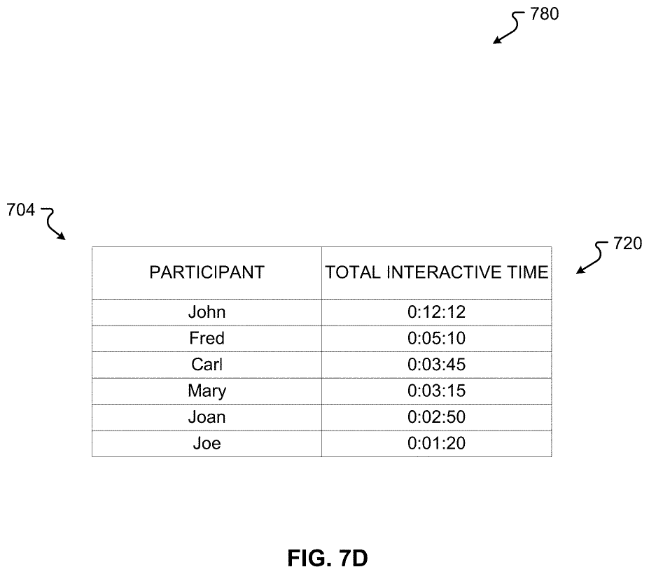

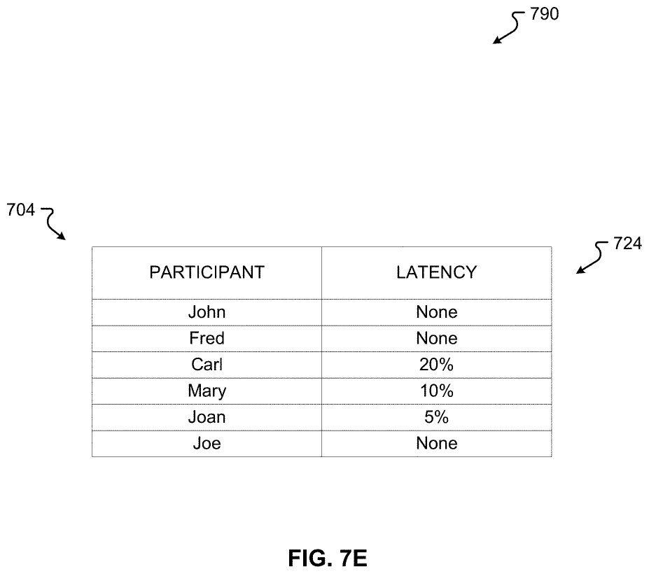

The timing module 335 according to one embodiment of the present disclosure, records the time each participant to the conference call joins the conference call. As illustrated in FIG. 7B, which will be explained in greater detail below, participant Fred is the first participant to join while participant Mary is the last participant to join the conference call. According to a further embodiment of the present disclosure, the timing module 335 also accumulates the amount of time each participant speaks during the conference call. The timing module 335 in cooperation with the monitoring module 325 detects the speech for each of the participants and keeps track of how much time each participant is speaking during the conference call. According to an alternative embodiment of the present disclosure, the AI of the application server 170 monitors the amount of time each participant is speaking during the conference call and can provide this information to the host or moderator of the conference call. As illustrated in FIG. 7C, which will be explained in greater detail below, participant John has the most amount of accumulated speaking time during the conference call and participant Joe has the least amount of accumulated speaking time during the conference call.

The latency module 340 determines any latency issues regarding the communication devices of the participants and network services for the conference call. For example, during one or more prior conference calls, information such as caller ID information, path information between the conference server 140 and the communication devices, geographic information such as on which continent or in which state a communication device is located, and the like, can be saved with each of these types of information having an associated latency that has been previously determined. For example, the latency module 340 cooperating with memory 360 and database 370, can monitor a plurality of communication channels and the information associated therewith and record the latencies associated with the communication paths used for the conference calls Exemplary technologies used to determine latency include one or more of ping, traceroute, path ping, and the like.

According to embodiments of the present disclosure, the latency module 340 may compare communication signals over the communication channels of the network of the conference call with threshold signal evaluations. A measure of latency can include measurements of packet delay, jitter, a packet loss, a bandwidth, or other types of quality-of-service measurements According to an alternative embodiment of the present disclosure, the latency module 340 determines a latency score based on applying a weight to the communication channels of the conference call. This score can be used to determine which participant of the conference call has priority and allowed to speak first when more than one participant to the conference call tries to speak at the same time. As illustrated in FIG. 7E which is described in greater detail below, participants Carl, Mary and Joan, have an associated latency value of 20%, 10% and 5%, respectively, compared to participants John, Fred and Joe that do not have any latency issues. According to one embodiment of the present disclosure, the latency values of 20%, 10% and 5% represent how much more consideration in terms of percentage is given to a participant experiencing a latency issue compared to participants experiencing no latency issue or a different latency issue. For example, if Carl's latency value of 20% is lower than a threshold value, Carl would be allowed to speak first if Carl and John, Fred or Joe begin speaking at the same time.

The conferencing module 320, according to one embodiment of the present disclosure, provides a conference call service to users of the communication devices by controlling conference calls that are in progress. The conferencing module 320 cooperates with participant module 310 and database 370 which stores information about persons registered as users to the conference server 140. For example, the database 370 includes a record for each user, which record indicates its name, credentials, network address of the communication devices and so on. The database 370 stores information about any conference calls that are in progress. For example, the database 370 includes a record for each conference call (in progress), which record indicates its participants; in turn, for each participant the record indicates the network address of the communication devices and its current mode (mute/unmute). The conferencing module 320 performs a bridge function that mixes the signals from each of the participants to the conference call.

The muting module 330, according to one embodiment of the present disclosure, is configured to mute the communication devices of each of the plurality of communication devices according to the instructions of the conferencing module 320 and the input provided by the priority algorithm module 315. According to an embodiment of the present disclosure, the muting module 330 mutes a microphone of the communication device of the participant(s) that has not been selected as the speaker.

The priority algorithm module 315 determines a priority algorithm for participants to the conference call. According to embodiments of the present disclosure, priority algorithms may include a latency priority algorithm which gives priority to participants experiencing latency issues.

Priority algorithms may also include a ranking (e.g., participant hierarchy) priority algorithm which gives priority to participants ranked higher in an organization or business for example. According to an alternative embodiment of the present disclosure, the ranking priority algorithm can also be based on the type of invitation to the participant to the conference call. For example, participants invited as an essential participant have a higher priority over participants invited as a nonessential participant. This is similar to a main recipient of an email having higher priority over a carbon copy (cc) or blind carbon copy (cc) recipient to an email. According to a further embodiment of the present disclosure, the ranking priority algorithm includes ranking based on a meeting group (e.g., moderator verses listeners or participants.)

According to embodiments of the present disclosure, the priority algorithms may further include time-based priority algorithms including a time of joining priority algorithm, a time accumulated priority algorithm and a total interaction time priority algorithm. The time of joining priority algorithm gives priority to participants to the conference call that join the conference call at an earlier time compared to other participants to the conference call that joined at a later time as discussed above in FIG. 7B. Processor 350 or the moderator or host of the conference call can override the selected time-based priority algorithm, for any reason such as a participant joining the conference call late because the participant was on another call, the participant is most knowledgeable about a topic being discussed, etc.

The time accumulated priority algorithm either gives priority to the participants to the conference call that contributes the most amount of speaking time during the conference call or gives priority to the participants of the conference call that contributes the least amount of speaking time during the conference call as illustrated in FIG. 7C According to an embodiment of the present disclosure, participants that contribute the most amount of speaking time can be an indication that the participants are most knowledgeable about the topics being discussed during the conference call or that the participant is the host or moderator of the conference call and should be given priority.

Alternatively, participants that have contributed the least amount of speaking time to the conference call maybe an indication that these participants have not been given a fair chance to contribute to the conference call because other participants are more outspoken and monopolize the time during the conference call. Therefore, participants that have contributed the least to the conference call thus far, should be given priority. According to a further embodiment of the present disclosure, participants that have contributed the least amount of speaking time to the conference call may yield their speaking time to another participant for any reason such as for example, yielding their speaking time to a participant more knowledgeable about the topic being discussed. According to embodiments of the present disclosure, if the participant is most knowledgeable about the topic being discussed but has already contributed a threshold amount of speaking time to the conference call, processor 350 or the AI from the application server 170 can override the selected priority algorithm and have the participant most knowledgeable about the topic to continue to speak.

A total interaction time priority algorithm gives priority to participants that not only have an accumulated amount of speaking time during the conference call, but also includes an accumulated amount of non-speaking time during the conference call. This accumulated amount of non-speaking time can include chat messages exchanged (e.g., instant messages (IM)), documents shared between participants, emails shared between participants and screensharing activities between participants for example. The monitoring module 325 may be used to gather this accumulated amount of non-speaking time. This interactive time provides an indication as to which participants are just listening to the conversations during the conference call and which participants are actively participating.

According to one embodiment of the present disclosure, the total interaction time priority algorithm also takes into consideration the time between questions addressed to a recipient of these questions. For example, a recipient may be barraged with questions from other participants to the conference call that the recipient cannot answer fast enough. The total interaction time priority algorithm in association with the speech analyzer of the monitoring module 325 and the AI from the application server 170 determines if the recipient has enough time to answer a first question before a next set of questions is asked. Therefore, if the recipient is designated as the speaker, then other participants are not allowed to speak until the recipient finishes answering the first question, based for example on the results from the speech analyzer which recognizes the recipient's voice. According to an alternative embodiment of the present disclosure, the total interaction time priority algorithm in association with the speech analyzer of the monitoring module 325 and the AI from the application server 170 may record subsequent questions from other participants addressed to the recipient or invite other participants to provide subsequent questions in an email or a chat while the recipient is answering the first question. Therefore, the recipient has a record of all questions being asked without having to write down the subsequent questions or remember the subsequent questions.

According to further embodiments of the present disclosure, the priority algorithms may also include a topic priority algorithm that gives priority to the participants that are most knowledgeable about a topic being discussed during the conference call. For example, topics or keywords gathered from previous conference calls, emails, IMs, etc. by the monitoring module 325 and stored in the database 370 can determine topics and/or keywords for a current conference call. Participants using the topics and/or keywords during the conference call have priority over participants to the conference call that do not use these topics and/or keywords during the conference call. The topic priority algorithm may be used for, but not restricted to, a voice session, a video session, a Short Message Service (SMS), a web chat, an Instant Messaging (IM), an email session, an Interactive Voice Response (IVR) session, a Voice over Internet Protocol (VoIP) session, and so forth.

According to embodiments of the present disclosure, if a speaker has been selected and asks a question to the other participants to the conference call, which may require more than one participant to speak at the same time, the speaker could be assigned a “token” which the speaker would keep until the speaker's question(s) have been answered or a time limit has been reached.

According to further embodiments of the present disclosure, each of the participants to the conference call could be allocated a specific amount of time to speak during the conference call. For example, if the conference call is to last for 60 minutes and there are 6 participants, each participant is given 10 minutes to speak. The participants would be prompted when it is time for the participant to speak and likewise prompted when it is time for the participant that is currently speaking to stop speaking because a time limit has expired.

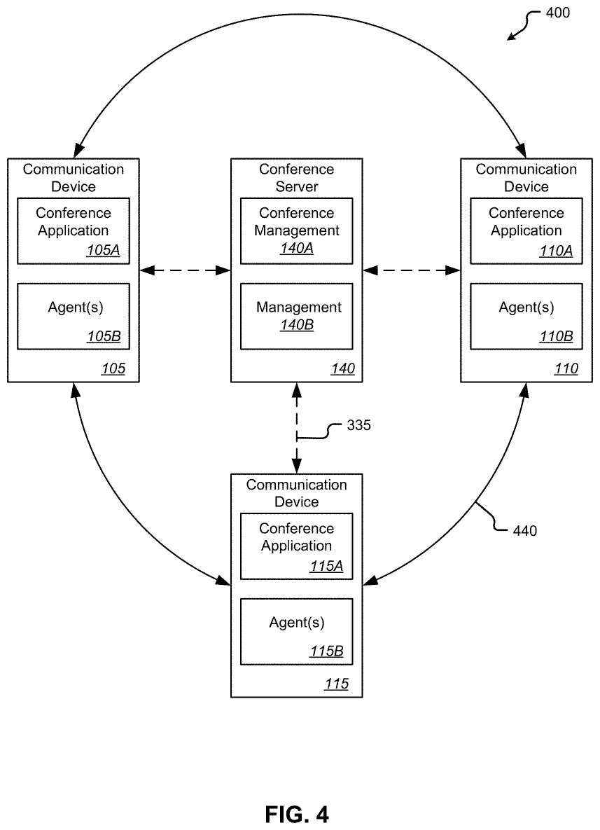

FIG. 4 is a block diagram of an illustrative communication system 400 for managing participants to a conference call based on fairness according to an embodiment of the present disclosure. As illustrated in this example, the communication system 400 can include conference server 140 as described above supporting a number of communication devices 105, 110, 115. The communication devices 105,110,115 can communicate with the conference server 140 and each other over a network (not shown here) such as the Internet or another wide-area or local-area network as described above.

The conference server 140 can execute a number of different applications including but not limited to one or more communication management applications 140B and/or one or more conference management applications 140A For example, the communication management application(s) 140B can comprise Web Real-Time Communication (WebRTC) and related server applications as known in the art. The conference management application(s) 140A can comprise one or more server applications to manage a conference communication session according to embodiments described herein.

Similarly, each communication device 105, 110, 115 can execute applications including but not limited to a communication agent 105B, 110B, 115B and a conferencing application 105A, 110A, 115A. Generally speaking, the communication agents 105B, 110B, 115B can comprise applications allowing each communication device 105, 110, 115 to communicate with the conference server 140 and/or each other. For example, the communication devices 105, 110, 115 can comprise WebRTC agents and/or related applications. The conference applications 105A, 110A, 115A can comprise applications, applets or “apps,” scripts, e.g., a Jitsi script or Javascript, or other executable code, e.g., received from the conference server 140 and/or another server (not shown here), which, when executed by the communication devices 105, 110, 115, provides an interface and a number of conference functions as will be described herein.

It should be noted that, while illustrated here as a single server 140 for the sake of clarity and simplicity, the conference server 140 can comprise one or more physical and/or virtual machines which may be co-located or distributed as known in the art. Similarly, while three communication devices 105, 110, 115 are illustrated here by way of example, any number of two or more communication devices 105, 110, 115 may join a conference as a participant or a spectator as will be described herein. The communication devices 105, 110, 115 can include any computing device capable of communicating within the system 400 and performing the functions as described herein and can include but are not limited to any combination of personal computers, laptops, tablets, cellphones, other mobile devices, etc. As noted, the communication devices 105, 110, 115 can communicate with the conference server 140 and each other over one or more networks (not shown here) such as the Internet and/or another wide-area or local-area network including both wired and wireless networks. Other elements and components of the system 400 as commonly known in the art and used to support such communications are contemplated and considered to be within the scope of the present disclosure.

As known in the art, a group or conference communication such as a video conference can be initiated between the communication devices 105, 110, 115 through the conference server 140. For example, a particular communication device 105 operated by an originator of the conference (for example user 101 illustrated in FIG. 1) can initiate a session with one or more other communication devices 110, 115 by requesting, through the WebRTC protocol, the conference server 140 to establish a conference and invite the one or more other communication devices 110, 115. As known in the art, to establish a WebRTC interactive flow (e.g., a real-time video, audio, and/or data exchange), communication devices 105, 110, 115 may retrieve WebRTC-enabled web applications, such as HTMLS/JavaScript web applications comprising the conference application 105A, 101A, 115A and communication agents 105B, 110B, 115B, from the conference server 140 or another server acting as web application server Through communication agents 105B, 110B, 115B, the communication devices 105, 110, 115 can then engage in a media negotiation to communicate and reach an agreement on parameters that define characteristics of the interactive session. In some embodiments, the media negotiation may be implemented via a WebRTC offer/answer exchange A WebRTC offer/answer exchange and other signaling exchanges of the conference typically occurs via a secure network connection 440 such as a Hyper Text Transfer Protocol Secure (HTTPS) connection or a Secure Web Sockets connection. In a WebRTC offer/answer exchange, a first WebRTC client on a sender communication device 105, referred to herein as the originator, sends an “offer” to a second communication device 110 referred to herein as a participant. The offer includes a WebRTC session description object that specifies media types and capabilities that the first WebRTC client supports and prefers for use in the WebRTC interactive flow. The second communication device 110 can then respond with a WebRTC session description object “answer” that indicates which of the offered media types and capabilities are supported and acceptable by the second communication device 110 for the WebRTC interactive flow. Additional communication devices 115 can be invited and join in a similar manner. Once the media negotiation is complete, the communication devices 105, 110, 115 may then establish a direct peer connection 440 with one another and may begin an exchange of media and/or data packets transporting real-time communications. The peer connection 440 between the communication devices 105, 110, 115 can employ, for example, the Secure Real-time Transport Protocol (SRTP) to transport real-time media channels, and may utilize various other protocols for real-time data interchange.

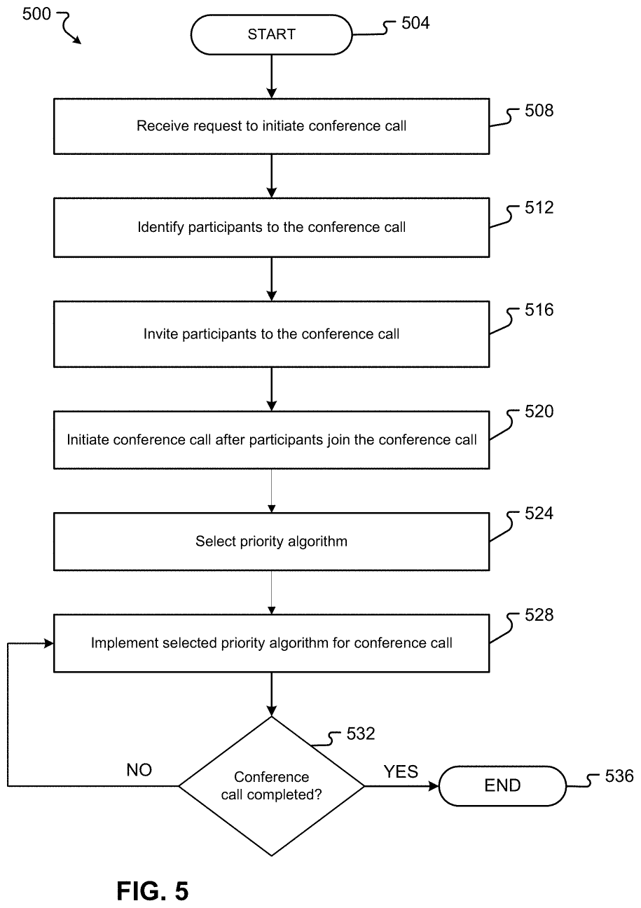

FIG. 5 is a flow diagram of a method 500 used for managing participants to a conference call based on fairness and network capabilities according to an embodiment of the present disclosure. While a general order of the steps of method 500 is shown in FIG. 5, method 500 can include more or fewer steps or can arrange the order of the steps differently than those shown in FIG. 5. Further, two or more steps may be combined into one step. Generally, method 500 starts with a START operation at step 504 and ends with an END operation at 536. Method 500 can be executed as a set of computer-executable instructions executed by a data-processing system and encoded or stored on a computer readable medium. Hereinafter, method 500 shall be explained with reference to systems, components, modules, software, data structures, user interfaces, etc. described in conjunction with FIGS. 1-4.

Once the conference call has been initiated, embodiments of the present disclosure provide for managing the conference call so that when more than one participant begins to speak at the same time, the priority algorithm module activates a selected priority algorithm which is based on fairness to determine which participant speaks first After determining which participants speaks first, the other participants are then muted. Method 500 starts with the START operation at step 504 and proceeds to step 508, where the processor 350 of conference server 140 receives a request to initiate a conference call. After receiving a request to initiate a conference call at step 508, method 500 proceeds to step 512, where the processor 350 of the conference server 140 identifies participants to the conference call. After identifying participants to the conference call at step 512, method 500 proceeds to step 516, where the processor 350 of the conference server 140 invites the participants to the conference call. After inviting the participants to the conference call at step 516, method 500 proceeds to step 520, where the processor 350 of the conference server 140 initiates the conference call after the participants join the conference call. According to one embodiment of the present disclosure, the conference call is initiated after a predetermined number of participants join the conference call. This predetermined number of participants can have a minimum value of two participants. According to an alternative embodiment of the present disclosure, the conference call is initiated after all of the participants join the conference call.

After initiating the conference call at step 520, method 500 proceeds to step 524, where the processor 350 of the conference server 140 selects a priority algorithm. According to one embodiment of the present disclosure, a priority algorithm is automatically selected as a default setting after initiating the conference call. The default setting may be one of the latency priority algorithm, the ranking priority algorithm, the time-based priority algorithms or the topic priority algorithm as discussed above. According to an alternative embodiment of the present disclosure, the host, moderator or administrator of the conference call has the option of selecting a priority algorithm before or after the conference call has been initiated. The other participants to the conference call would be unaware of this selection by the host, moderator or administrator and not know what priority algorithm is being applied during the conference call. The host, moderator or administrator would be provided, by the processor 350 of the conference server 140, with a list of priority algorithms from which to select a priority algorithm.

According to an embodiment of the present disclosure, the host, moderator or administrator has the ability to adjust the selection of the priority algorithm during the conference call even after a first priority algorithm has been selected. For example, if the total interaction time priority algorithm was first selected at the beginning of the conference call, the host, moderator or administrator has the ability to change the priority algorithm during the conference call to another priority algorithm. The host, moderator or administrator can change the priority algorithm to the ranking priority algorithm for example if the CEO of the company for example wants to speak. Alternatively, the selection of a priority algorithm may automatically be adjusted by canceling a first selected priority algorithm and selecting another priority algorithm. According to an embodiment of the present disclosure, the processor 350 cooperating with the timing module 335 and/or the monitoring module 325 may determine that a speaking time of one or more participants to the conference call is below a threshold value at a certain point during the conference call. For example, this certain point could be halfway during the conference call. The processor 350 cooperating with the timing module 335 and/or the monitoring module 325 reevaluates the selected priority algorithm since fairness is not being achieved because of the speaking time of one or more participants is below a threshold value. The processor 350 cooperating with the timing module 335 and/or the monitoring module 325 reevaluates the priority algorithm by canceling the current priority algorithm and selecting another priority algorithm in an attempt to improve the speaking time of the participants having speaking times below the threshold value. The selection of another priority algorithm may be based on factors determined during the monitoring of the conference call by the monitoring module 325. Alternatively, the processor 350 can provide an indication to the host, moderator or administrator that the speaking time of one or more participants is below a threshold value and solicit instructions from the host, moderator or administrator to adjust the selected priority algorithm.

According to a further embodiment of the present disclosure, voting may be performed by the host or moderator and any or all of the participants to the conference call to determine which priority algorithm will be selected to be used during the conference call. For example, a majority of the participants to the conference call can determine which priority algorithm will be selected to be used during the conference call. Therefore, if three out of five participants to the conference call select a particular priority algorithm to be used during the conference call, then that particular priority algorithm will be used.

Additionally or alternatively, more than one priority algorithm may be selected. For example, the latency priority algorithm may be selected as the first priority algorithm, followed by the ranking priority algorithm as the second priority algorithm and then one of the time-based priority algorithms as the third priority algorithm.

After selecting a priority algorithm at step 524, method 500 proceeds to step 528, where the processor 350 of the conference server 140 implements the selected priority algorithm for the conference call. After implementing the selected priority algorithm at step 528, method 500 proceeds to decision step 532 where the processor 350 of the conference server 140 determines if the conference call has been completed. The conference call is completed if the moderator or host ends the conference call or a predetermined period of time for conducting the conference call has expired. If the conference call has been completed (YES) at decision step 532, method 500 ends at END operation 536. If the conference call has not been completed (NO) at decision step 532, method 500 returns to step 528 where the processor 350 of the conference server 140 implements the selected priority algorithm for the conference call.

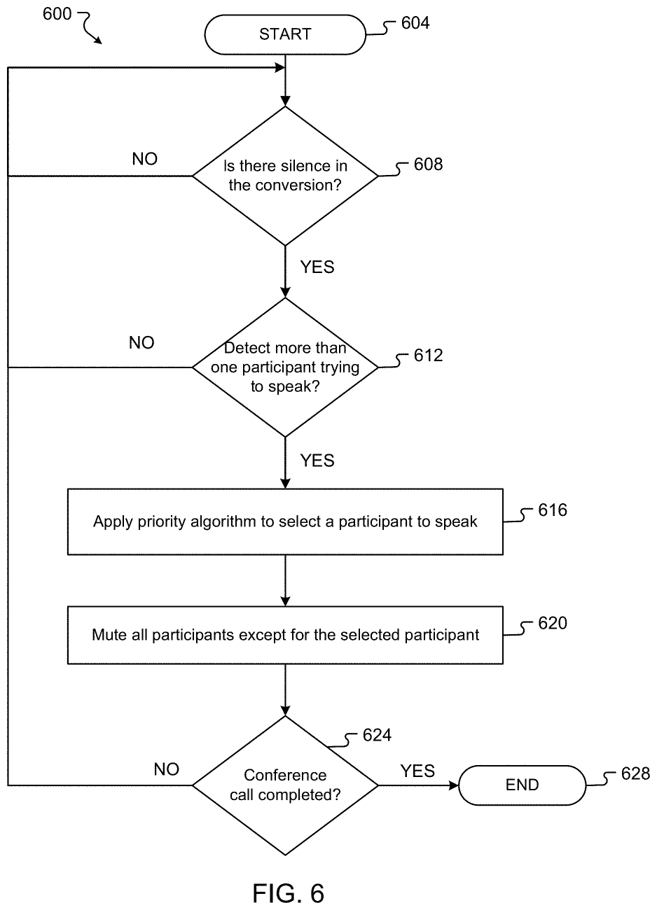

FIG. 6 is a flow diagram illustrating additional details of a method 600 implementing the priority algorithm used for managing participants to a conference call based on fairness according to an embodiment of the present disclosure. While a general order of the steps of method 600 is shown in FIG. 6, method 600 can include more or fewer steps or can arrange the order of the steps differently than those shown in FIG. 6. Further, two or more steps may be combined into one step. Generally, method 600 starts with a START operation at step 604 and ends with an END operation at 628. Method 600 can be executed as a set of computer-executable instructions executed by a data-processing system and encoded or stored on a computer readable medium. Hereinafter, method 600 shall be explained with reference to systems, components, modules, software, data structures, user interfaces, etc. described in conjunction with FIGS. 1-4.

Method 600 starts with the START operation at step 604 and proceeds to decision step 608, where the processor 350 of conference server 140 determines if there is silence in the conversation of the conference call. If there is no silence in the conversation of the conference call (NO) at decision step 608, method 600 returns to decision step 608 to determine if there is silence in the conversation of the conference call. If there is silence in the conversation of the conference call (YES) at decision step 608, method 600 proceeds to decision step 612, where the processor 350 of conference server 140 determines if more than one participant is trying to speak at the same time. If no more than one participant is trying to speak (NO) at decision step 612, method 600 returns to decision step 608 to determine if there is silence in the conversation of the conference call. If more than one participant is trying to speak at the same time (YES) at decision step 612, method 600 proceeds to step 616 where the processor 350 of conference server 140 applies the selected priority algorithm to select a participant to speak when more than one participant is trying to speak at the same time. After applying the selected priority algorithm to select a participant to speak when more than one participant is trying to speak at one time at step 616, method 600 proceeds to step 620 where the processor 350 of conference server 140 mutes all participants except for the selected participant. After muting all participants except for the selected participant at step 620, method 600 proceeds to decision step 624 where the processor 350 of conference server 140 determines if the conference call has been completed. The conference call is completed if the moderator or host ends the conference call or a predetermined period of time for conducting the conference call has expired. If the conference call has been completed (YES) at decision step 624, method 600 ends at END operation 628. If the conference call has not been completed (NO) at decision step 624, method 600 returns to decision step 608 where the processor 350 of the conference server 140 determines if there is silence in the conversation of the conference call.

FIGS. 7A-7E are block diagrams of illustrative database entries 750-790, respectively, used for managing participants to a conference call based on fairness according to embodiments of the present disclosure. As illustrated in FIG. 7A, data entry 750 includes a list of participants 704 and a corresponding list of ranks and titles 708 for the list of participants. The hierarchy of the participants 704 may be set according to the policies of the conference call, which may be determined by, for example, a moderator or host of the conference call and stored in database 370. According to one embodiment of the present disclosure, the conference host or the moderator is given top priority.

As illustrated in FIG. 7B, data entry 760 includes a list of participants 704 and a corresponding list of times joined 712 for the list of participants to the conference call. As illustrated in FIG. 7C, data entry 770 includes a list of participants 704 and a corresponding list of times accumulated 716 for the list of participants to the conference call. As illustrated in FIG. 7D, data entry 780 includes a list of participants 704 and a corresponding list of total interaction time 720 for the list of participants to the conference call. These time-based priority algorithms give priority to participants to the conference call based on the time the participants joined the conference call or the amount of speaking time and/or non-speaking time accumulated during the conference call According to one exemplary embodiment of the present disclosure, if the time of joining priority algorithm is selected as the priority algorithm and two participants (e.g., Joe and Joan) begin to speak at the same time during the conference call, the priority algorithm module 315 in cooperation with the timing module 335 determines that Joe should speak first since Joe joined the conference call prior to Joan joining the conference call as illustrated in FIG. 7B.

According to another exemplary embodiment of the present disclosure, if the time accumulated priority algorithm is selected as the priority algorithm and two participants (e.g., Fred and Carl) begin to speak at the same time during the conference call, priority algorithm module 315 in cooperation with the timing module 335 determines that Fred should speak first since Fred has the most accumulated talk time during the conference call.

According to a further exemplary embodiment of the present disclosure, if the total interaction time priority algorithm is selected as the priority algorithm and two participants (e.g., Fred and Carl) begin to speak at the same time during the conference call, priority algorithm module 315 in cooperation with the timing module 335 and/or the monitoring module 325 and AI functionality determines that Fred should speak first since Fred has the most total interaction time during the conference call.

As illustrated in FIG. 7E, data entry 790 includes a list of participants 704 and a corresponding list of latency factors 724 for the list of participants to the conference call. Priority based on network latency issues includes giving priority to a participant to the conference call that suffers from the greatest network latency or has greater network issues as determined by latency module 340. According to embodiments of the present disclosure, network latencies affect the ability of participants to quickly join into the conference call and may be prevented from speaking as compared with participants that do not suffer from network latency issues. According to an alternative embodiment of the present disclosure, the network latency can be used as a weighted factor along with another priority algorithm.

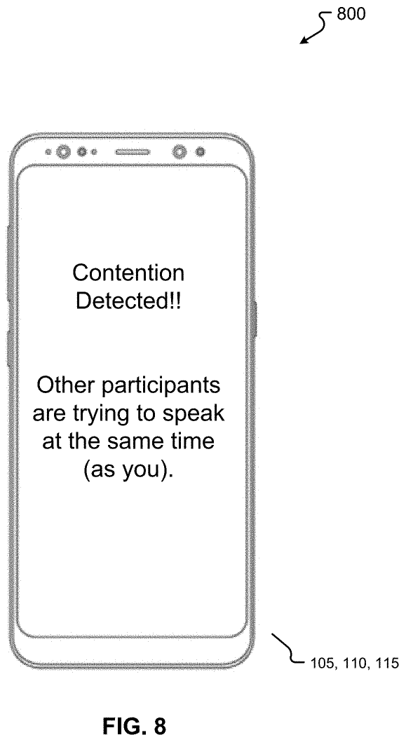

FIG. 8 is a screenshot 800 illustrating an exemplary user interface used in managing participants to a conference call based on fairness according to an embodiment of the present disclosure. As illustrated in FIG. 8, each participant to the conference call receives a visual message that reads “Contention Detected!! Other participants are trying to speak at the same time” when more than one participant to the conference call is trying to speak at the same time. According to an alternative embodiment of the present disclosure, only the participants involved in the contention receive the visual message. In this case, the message may read “Contention Detected!! Other participants are trying to speak at the same time as you” when more than one participant to the conference call is trying to speak at the same time. Additionally or alternatively, each participant to the conference call or only participants to the conference call involved in the contention receive an audio message in the form of a whisper tone or other low-volume announcement, indicating a contention has been detected.

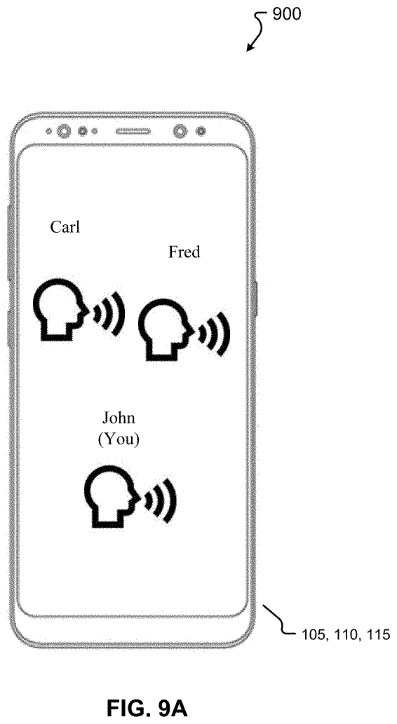

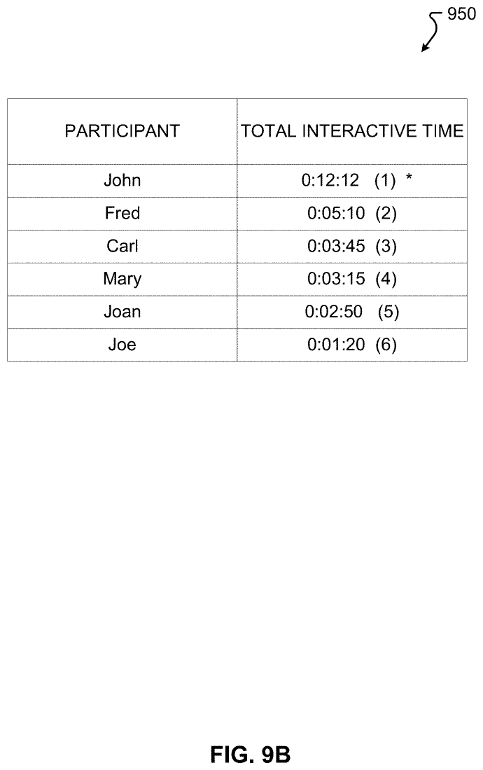

FIG. 9A is a screenshot 900 illustrating an exemplary user interface used in managing participants to a conference call based on fairness according to an embodiment of the present disclosure. As illustrated in FIG. 9A, the participants involved in the contention are displayed to each of the participants. According to an alternative embodiment of the present disclosure, only the participants involved in the contention are displayed to the corresponding participants. As illustrated in FIG. 9A, participants John, Fred and Carl are involved in the contention. Therefore, either each of the participants to the conference call receives a visual display provided with the names John, Fred and Carl along with icon representing the participants or just participants Joe, Fred and John receive the visual display. Additionally or alternatively, each participant to the conference call or only participants to the conference call involved in the contention receive, an audio message in the form of a whisper tone or other low-volume announcement, indicating that John, Fred and Carl are involved in a contention to determine which participant is to speak first.

FIG. 9B is a block diagram of an illustrative database entry 950 used for managing participants to a conference call based on fairness according to an embodiment of the present disclosure. As illustrated in FIG. 9B, the database entry ranks the participants based on the total interaction time priority algorithm.

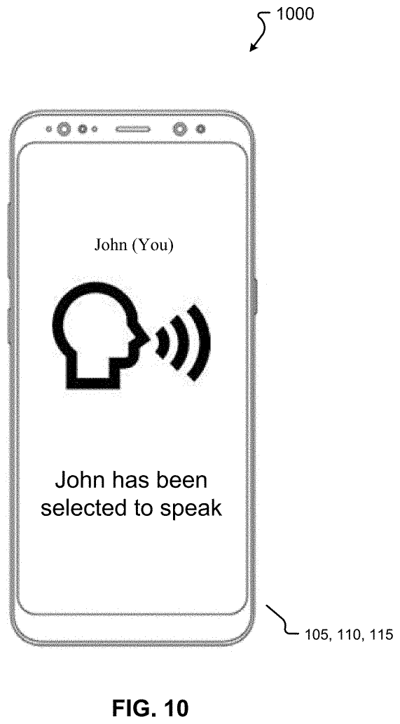

FIG. 10 is a screenshot 1000 illustrating an exemplary user interface used in managing participants to a conference call based on fairness according to an embodiment of the present disclosure. As illustrated in FIG. 10, participant John has been selected to speak based on the fact that the total interaction time priority algorithm has been selected. After John has been selected to speak, the remainder of the participants are muted. Additionally or alternatively, each participant to the conference call or only participants to the conference call involved in the contention receive an audio message in the form of a whisper tone or other low-volume announcement, indicating that John has been selected to speak and that the remainder of the participants have been muted.

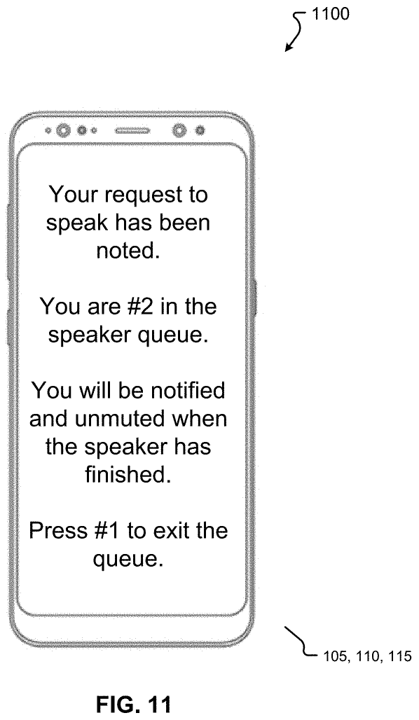

FIG. 11 is a screenshot 1100 illustrating an exemplary user interface used in managing participants to a conference call based on fairness according to an embodiment of the present disclosure. As illustrated in FIG. 11, participants Fred and Carl that were involved in the contention but not selected, receive a message stating “Your request to speak has been noted. You are (#1 or #2) in the speaker queue. You will be notified and unmuted when John has finished speaking. If you no longer wish to speak or your query was answered by a previous speaker, please press #1 to remove yourself from the queue.” If the participants Fred and Carl do not want to remain in the queue, they are given the option of exiting the queue. According to an alternative embodiment of the present disclosure, each of the participants to the conference call may be provided with a similar screen inviting each of the participants to join the queue after participants Fred and Carl.

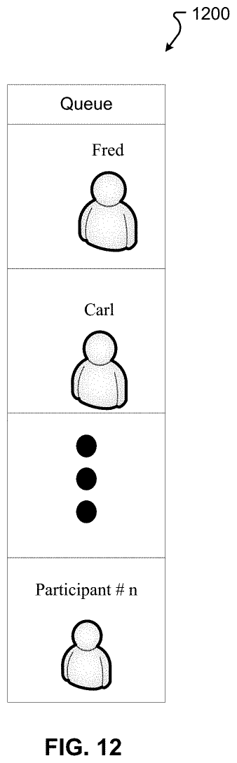

FIG. 12 is a screenshot 1200 illustrating an exemplary user interface used in managing participants to a conference call based on fairness according to an embodiment of the present disclosure. As illustrated in FIG. 12, participants Fred and Carl are first and second members, respectively, of the queue. Other participants (e.g., participant #n) can join the queue after Fred and Carl. Additionally or alternatively, each participant to the conference call or only participants to the conference call involved in the contention receive an audio message in the form of a whisper tone or other low-volume announcement, indicating the participant's position within the queue.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally, or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a CPU with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), ROM, programmable read-only memory (PROM), erasable programmable read-only memory (EPROM), RAM, bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion coprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this disclosure have been described in relation to communications systems and components and methods for monitoring, enhancing, and embellishing communications and messages. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA@ or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A method for managing a conference call, comprising:
receiving, by a processor, a request to initiate a conference call with a plurality of participants;
initiating, by the processor, the conference call with the plurality of participants in response to receiving an acceptance from at least two of the plurality of participants;
receiving, by the processor, a selection of at least one priority algorithm to be applied during the conference call to determine which participant has priority as a speaker when an attempt is made by more than one participant to speak at substantially a same time;
detecting, by the processor, the attempt made by the more than one participant to speak at substantially the same time;
applying, by the processor, the received selection of at least one priority algorithm to determine which participant of the more than one participant that attempted to speak at substantially the same time has priority;
selecting, by the processor, one participant of the more than one participant that attempted to speak at substantially the same time as the speaker;
computing, by the processor, an accumulated amount of speaking time during the conference call for each participant; and
transmitting, by the processor, a video that generates icons for display, representing a conflict occurring between each participant attempting to speak at substantially the same time, to the communication devices of each participant attempting to speak at substantially the same time.

2. The method for managing a conference call according to claim 1, wherein the at least one priority algorithm includes a participant hierarchy priority algorithm, time-based priority algorithms, a topic-based priority algorithm or a latency-based priority algorithm.

3. The method for managing a conference call according to claim 2, further comprising receiving, by the processor, a first selection of the at least one priority algorithm from a host of the conference call or from a majority of the participants voting for the at least one priority algorithm.

4. The method for managing a conference call according to claim 3, wherein the first selection of the at least one priority algorithm includes a time-based priority algorithm including the accumulated amount of speaking time during the conference call for each participant.

5. The method for managing a conference call according to claim 4, further comprising computing, by the processor, an accumulated amount of non-speaking time during the conference call for each participant and wherein the time-based priority algorithm includes the accumulated amount of non-speaking time during the conference call for each participant.

6. The method for managing a conference call according to claim 5, wherein the accumulated amount of non-speaking time includes at least one of text chats, instant messages, emails, shared documents, or screensharing activities.

7. The method for managing a conference call according to claim 1, further comprising indicating, by the processor, the accumulated amount of speaking time of each participant to the conference call that is below a threshold value.

8. The method for managing a conference call according to claim 7, further comprising receiving, by the processor, a request to cancel the first selection of the at least one priority algorithm and make another selection of the at least one priority algorithm based on the indication that the participants to the conference call have a speaking time during, a portion of the conference call, that is below the threshold value for a remainder of the conference call.

9. The method for managing a conference call according to claim 1, further comprising:
indicating, by the processor, the accumulated amount of speaking time of at least one participant of the participants to the conference call, that is above a threshold value; and
lowering, by the processor, a ranking in priority of the at least one participant to the conference call with respect to other participants to the conference call, based on the indication that the at least one participant has an accumulated amount of speaking time, during a portion of the conference call, above the threshold value.

10. The method for managing a conference call according to claim 1, further comprising muting, by the processor, communication devices of a remainder of the plurality of participants not selected as the speaker.

11. The method for managing a conference call according to claim 10, further comprising transmitting, by the processor, a video signal to the communication devices of the remainder of the plurality of participants for generating a display message indicating that the participant has been muted.

12. (canceled)

13. A system, comprising:
a processor; and
a memory coupled with and readable by the processor and having stored therein a set of instructions which, when executed by the processor, causes the processor to manage a conference call by:
receiving a request to initiate a conference call with a plurality of participants;
initiating the conference call with the plurality of participants in response to receiving an acceptance from at least two of the plurality of participants;
receiving a selection of at least one priority algorithm to be applied during the conference call to determine which participant has priority as a speaker when an attempt is made by more than one participant to speak at substantially a same time;
detecting the attempt made by the more than one participant to speak at substantially the same time;
applying the received selection of at least one priority algorithm to determine which participant of the more than one participant that attempted to speak at substantially the same time has priority; selecting one participant of the more than one participant that attempted to speak at substantially the same time as the speaker;
computing an accumulated amount of speaking time during the conference call for each participant; and
transmitting, by the processor, a video that generates icons for display, representing a conflict occurring between each participant attempting to speak at substantially the same time, to the communication devices of each participant attempting to speak at substantially the same time.

14. The system according to claim 13, wherein the at least one priority algorithm includes a participant hierarchy priority algorithm, time-based priority algorithms, a topic-based priority algorithm or a latency-based priority algorithm.

15. The system according to claim 14, wherein the selection of the at least one priority algorithm includes a time-based priority algorithm including the accumulated amount of speaking time during the conference call for each participant.

16. The system according to claim 13, further comprising:
indicating the accumulated amount of speaking time of at least one participant of the participants to the conference call, that is above a threshold value; and
lowering a ranking in priority of the at least one participant to the conference call with respect to other participants to the conference call, based on the indication that the at least one participant has an accumulated amount of speaking time, during a portion of the conference call, above the threshold value.

17. A computer-readable medium comprising a set of instructions stored therein which, when executed by a processor, causes the processor to manage a conference call by:
receiving a request to initiate a conference call with a plurality of participants;
initiating the conference call with the plurality of participants in response to receiving an acceptance from at least two of the plurality of participants;
receiving a selection of at least one priority algorithm to be applied during the conference call to determine which participant has priority as a speaker when an attempt is made by more than one participant to speak at substantially a same time;
detecting the attempt made by the more than one participant to speak at substantially the same time;
applying the received selection of at least one priority algorithm to determine which participant of the more than one participant that attempted to speak at substantially the same time has priority;
selecting one participant of the more than one participant that attempted to speak at substantially the same time as the speaker;
computing an accumulated amount of speaking time during the conference call for each participant; and
transmitting, by the processor, a video that generates icons for display, representing a conflict occurring between each participant attempting to speak at substantially the same time, to the communication devices of each participant attempting to speak at substantially the same time.

18. The computer-readable medium according to claim 17, wherein the at least one priority algorithm includes a participant hierarchy priority algorithm, time-based priority algorithms, a topic-based priority algorithm or a latency-based priority algorithm.

19. The computer-readable medium according to claim 18, wherein the selection of the at least one priority algorithm includes a time-based priority algorithm including the accumulated amount of speaking time during the conference call for each participant.

20. The computer-readable medium according to claim 17, further comprising:
indicating the accumulated amount of speaking time of at least one participant of the participants to the conference call, that is above a threshold value; and
lowering a ranking in priority of the at least one participant to the conference call with respect to other participants to the conference call, based on the indication that the at least one participant has an accumulated amount of speaking time, during a portion of the conference call, above the threshold value.

21. The computer-readable medium according to claim 19, further comprising computing an accumulated amount of non-speaking time during the conference call for each participant,
wherein the time-based priority algorithm includes the accumulated amount of non-speaking time during the conference call for each participant and
wherein the accumulated amount of non-speaking time includes at least one of text chats, instant messages, emails, shared documents, or screensharing activities.
